(19) United States
(12) Patent Application Publication
(10) Pub. No.: US 2001/0052727 A1
(43) Pub. Date: Dec. 20, 2001

(54) Integrated brake control system

(76) Inventor: William R. Betts, Staffordshire (GB)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/827,955

(22) Filed: Apr. 4, 2001

Related U.S. Application Data
(60) Provisional application No. 60/195,339, filed on Apr. 4, 2000.

(51) Int. Cl. B60T 8/32; B60T 8/42

(52) U.S. Cl. 303/191; 303/199; 303/115.2

(57) ABSTRACT

Braking systems including integrated control circuitry and sensors for measuring the pressure and temperature of the brake system and for determining various status information and performance parameters of the braking system and other related systems, such as tire and suspension systems.

### CROSS-REFERENCES TO RELATED APPLICATIONS

This application is related to, and claims priority from, U.S. Provisional Patent Application Ser. No. 60/195,339, filed Apr. 4, 2000, entitled “INTEGRATED BRAKE CONTROL SYSTEM,” the disclosure of which is hereby incorporated by reference in its entirety.

### BACKGROUND OF THE INVENTION

The present invention relates generally to vehicle braking systems and more particularly to vehicle braking systems that includes integrated pressure and temperature sensors and control circuitry for a reliable and cost effective implementation.

Brake systems in modern vehicles typically include a hydraulic circuit that transfers the braking effort of the driver from the brake pedal via a pipe system to the cylinders within the individual brake assemblies at the wheels. The hydraulic pressure applied to the cylinders causes the brake pads coupled to the cylinders to contact disks on the wheels. The pressure between the brake pad and the braked disc determines the actual braking effort of the brake system. In many vehicles such a brake systems is augmented by a power assist system that determines the effort put into the brake pedal by the driver and boosts the pressure transferred to the brake cylinders. Such systems allows for a level of braking effort to be applied that is greater than the braking effort an unaided driver applies. In other vehicles, the pressure transferred to the brake cylinders is modified based on the rotational speed of the wheel so as to reduce or eliminate unwanted wheel slip during acceleration and/or deceleration (braking) on wet or slippery surfaces.

As the transfer of the pressure from the brake pedal to the brake cylinder becomes increasingly dependent upon, or controlled by, systems within the vehicle rather than simply driver effort, there is less of a need for the direct transfer of pressure from the driver. Consequently, electric actuation systems are becoming more prevalent in the industry. The ability of electronically controlled and actuated systems to exceed the reliability of mechanical systems also encourages an electronic approach.

In electric actuation systems, an electronic control unit (ECU) typically determines the driver requirements by detecting the position of the brake pedal. The ECU then controls electric motors that creates, via mechanical means, pressure between the brake pads and the brake discs.

The separation of the braking effort for each wheel by the separate generation of the pressure between the brake pad and the brake disc on each wheel allows for a different control system to be implemented for both braking control and wheel slip control.

### SUMMARY OF THE INVENTION

The present invention provides braking systems including integrated control circuitry and sensors for measuring the pressure and temperature of the brake system and for determining various status information and performance parameters of the braking system and other related systems, such as tire and suspension systems.

According to the invention, a braking system for an automobile is provided. The system typically comprises a brake mechanism wherein the braking effort is created by the mechanical pressure between a fixed part connected to the chassis and a rotating part connected to the wheel. Typically the fixed part includes a cylinder coupled to a brake pad and the rotating part includes a disc coupled to the wheel. The system also typically includes an electric actuator that applies pressure to the fixed part such as to force it against the rotating part, and an electronic circuit embedded in, or mounted on, the fixed part or the actuation mechanism between the fixed part and the electric actuator. The electronic circuit typically includes a pressure sensor and associated circuitry to determine directly or by inference the pressure between the fixed part and the rotating part, a temperature sensor and associated circuitry to determine the temperature of the brake parts, and control circuitry to control the electric actuator. Also typically included is a communication link for linking the control circuitry with external intelligence. The control circuitry typically controls the electric actuator based on command signals received via the communication means and the signals from one or more of the sensor circuits. Data relating to the status of the brake system and the components therein is transmitted over the communication link from the control circuitry to the external intelligence and stored in a memory. The status information and other operating and characteristics data stored in the memory is used by the control circuitry and external intelligence for many applications including, for example: a) defining modes of operation, b) compensating for errors or non linearities in sensor signals, c) determining mechanical wear in braking materials, d) determining tire pressure, and e) determining suspension system performance parameters.

According to an aspect of the present invention, a vehicle brake system is provided for use in controlling the pressure of a brake pad applied to a disc on a wheel. The system typically includes a brake cylinder coupled to a brake pad and having a pressure-transmitting medium within the body of the cylinder, and an actuator configured to apply pressure to the brake cylinder in response to a control signal. The system also typically includes a pressure sensor configured to measure the pressure of the pressure transmitting medium and to provide a pressure signal, a temperature sensor configured to measure the temperature of the pressure transmitting medium and to provide a temperature signal, and a control circuit configured to receive and process the temperature and pressure signals and to provide the control signal to the actuator.

According to another aspect of the present invention, a vehicle brake system is provided for use in controlling the pressure of a brake pad applied to a disc on a wheel. The system typically includes a brake cylinder coupled to a brake pad and including a pressure-transmitting medium within the body of the cylinder, and an actuator configured to apply pressure to the brake cylinder in response to a control signal. The system also typically includes an integrated circuit coupled to the brake cylinder, the integrated circuit having a pressure sensor configured to measure the pressure of the pressure transmitting medium and to provide a pressure signal, a temperature sensor configured to measure the temperature of the pressure transmitting medium and to provide a temperature signal, and a control circuit configured to receive and process the temperature and pressure signals and to provide the control signal to the actuator.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates an arrangement of an integrated circuit in a brake system according to an embodiment of the present invention; and

FIG. 2 illustrates a system arrangement according to an embodiment of the present invention.

### DESCRIPTION OF THE SPECIFIC EMBODIMENTS

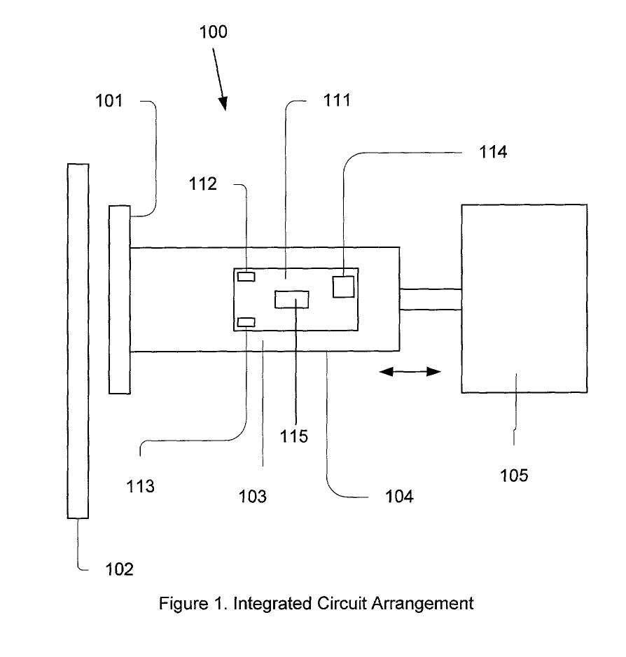

FIG. 1 illustrates an arrangement of an integrated circuit 111 in a vehicle brake system 100 according to an embodiment of the present invention. An individual brake system 100 is typically provided for each wheel for which braking control is desired. Each such wheel typically includes a disc 102 of suitable material which rotates with the wheel (not shown). Braking system 100 includes a pad 101 of suitable friction material mounted on a housing or casing 104 which in one embodiment is a hollow cylinder/tube as shown. It should be understood that a cylinder is but one possible geometric shape, and that housing 104 may having any geometric shape as desired. Pad 101 and disc 102 each include material as are well known in conventional braking systems. The brake pad 101 is pressed onto the rotating disc 102 to create the braking effort via friction. The brake pad 101 is pressed onto the disc 102 by the action of an electric actuator 105 mechanically coupled to housing 104. Electric actuator 105 includes an electric motor and necessary associated mechanical components as are well known. For example, such mechanical components include screw or worm gear arrangements to increase the mechanical efficiency of the motor.

According to one embodiment of the invention, the pressure between the pad 101 and the disc 102 is determined by measuring the pressure of a pressure-transmitting medium 103 within the housing 104. In one embodiment, pressure transmitting medium 103 includes a glycol with inhibitors, but any non-corrosive, non-organic fluid may be used. The housing 104 preferably has a controlled distortion characteristic to ensure that the pressure exerted by the pad on the disc is transferred to the medium 103 in a reproducible manner without reducing or negating the brake effectiveness. Mounted on or within the housing 104 is an electronic control circuit arrangement 111 that includes a pressure sensor 112, which is configured to measure the pressure of the medium 103 and produce an electric signal that represents the pressure of medium 103. Electronic control circuit arrangement 111 also includes a processing and control module 115, which includes associated electronic circuitry that processes the pressure signal to determine the pressure between the pad and the disc. Such associated electronic circuitry includes, e.g., circuit elements designed to remove, by filtering and digital processing, unwanted and extraneous signals produced by mechanical vibrations, wheel movement and road surface non-linearity effects. The filtering circuitry is used in one embodiment of the invention to generate signals that assist in determining further information including, for example, the mechanical health of the system, the state and inflation pressure of the tires, and the performance of the shock absorbers.

In one embodiment, electronic control circuit arrangement 111 also includes a temperature sensor 113, which is configured to measure the temperature of medium 103 and produce an electrical signal that represents the temperature of the medium 103. This temperature signal, being a function at least in part of the temperature of the brake pad and wheel, can be used to compensate for temperature effects in the accuracy of the pressure sensor 112. This temperature signal can also be used as an indication of a brake binding or other potentially serious wheel or brake problem.

In another embodiment, electronic control circuit arrangement 111 also includes an arrangement of one or more Hall effect sensors 114 that, dependent upon the mechanical arrangement, determine the angular position of, or the rotational speed of, one or both of the electric actuator motor 105 and the wheel (not shown). U.S. patent application Ser. No. 09/291,658, entitled “Temperature Control System,” (Atty. docket No. 016998-000900US) which is hereby incorporated by reference in its entirety for all purposes, shows examples of the operation of one or more hall effect sensors used to determine the angular position of a magnet on a rotatable element, e.g., control knob. It should be appreciated that the angular position of a magnet on a rotatable element such as a wheel or an actuator motor can be determined using similar techniques. It should also be appreciated that the angular velocity of a rotatable element is easily determined based on the time varying signal detected by the arrangement of one or more hall effect sensor(s).

In one embodiment, the Hall Effect sensor(s) 114 senses the rotation of the motor in the electric actuator 105 by sensing the speed at which a magnet located on the motor rotates relative to a fixed axis (e.g., axis of cylinder 104). The amount of movement required to create a given pressure is an indication of wear of the brake friction components, or in failure conditions an indication of mis-operation of the brake actuator.

Included in the electronic control circuit arrangement 111, control module 115 is arranged and configured to receive the signals from the sensors, e.g., temperature sensor 113, pressure sensor 112, and Hall Effect sensor 114, and to drive the electric actuator such as to press the brake pad 101 on the disc 102. The pressure sensor 112 is preferably used by the control module 115 in a control loop to set up any pre-defined brake pressure.

All components of electronic control circuit arrangement 111 are preferably integrated onto a single silicon chip, although individual components may be integrated on different chips with the appropriate interconnections for communication of the various signals between components.

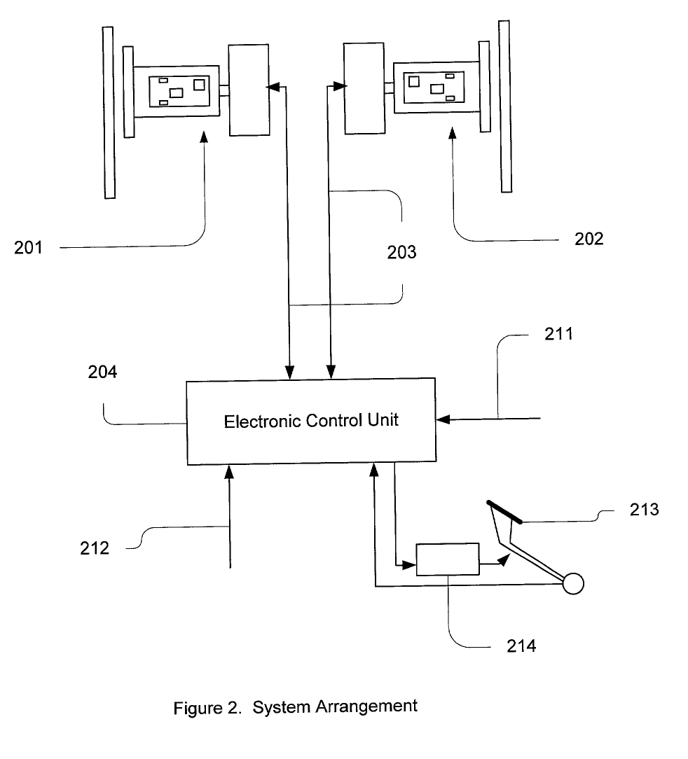

FIG. 2 illustrates a system arrangement including two brake system arrangements 201 and 202 according to an embodiment of the present invention. A communications link 203 provides a medium for command and data signals to be sent between the an external ECU 204 and each of the electronic control circuit arrangements (e.g., module 111 of FIG. 1) of brake system 201 and brake system 202. A typical signal sent from ECU 204 to the brake systems includes a command to select a predetermined brake pressure.

The commands received by each brake system vary from a simple ‘full application’ command, e.g., when the driver activates the park brake 211 for parking, to ‘apply x% brake pressure’ for normal braking. Commands can also include ‘pulse off’ during braking as part of traction control or anti skid control. It should be appreciated that different brake pressure commands can be simultaneously sent to the different brake systems as required by the application.

In one embodiment, a memory unit is integrated in the system and is used to store various system parameters. A memory unit is preferably coupled to ECU 204, but a memory unit may alternatively, or additionally, be integrated with, or coupled to, electronic control circuit arrangement 111. Stored data can be transmitted to and from processing and control module 115 and ECU 204 over the communication link 203. Data to be stored is calculated from data received from the various sensors or determined by algorithms from any of the aforementioned sources. Such stored data includes, for example:

a) Compensation data related to build, installation or application variables;

b) Historical data used to determine long term changes in performance or mechanical wear;

c) Characteristic data used to define ‘normal’ signals to assist in determining abnormal signals for the detection of out of range tire pressures or reduced performance in suspension components; and

d) Other data relating to the system as the application may determine or require.

The electronic control module 115 for each brake system is also preferably configured to send status information concerning various parameters of the braking system to the ECU 204. Such status information includes, for example, the performance of the brake, the wear of the brake determined from the change in required travel of the electric actuator over time, the operating temperature, the implied tire pressure, the status of the shock absorbers, etc.

In one embodiment, the Hall Effect sensor(s) 114 is used to measure the wheel speed and the control module 115 is configured to send the wheel speed data over the communication link 203 to ECU 204 to assist the ECU 204 in determining true speed over ground. True speed over ground is a useful parameter for determining appropriate command signals to be applied to the brake systems for anti skid braking and traction control applications. Additionally, or alternatively, a separate speed over ground signal 212 is supplied from some other means such as a ground sensing radar or other speed sensing device.

Additionally, or alternatively, the ECU 204 provides feedback signals to a brake pedal interface unit 214 that is provided for supplying ‘feel’ to the brake pedal 213, e.g., to present a resistance to the pedal movement and feed back to the driver via the driver's foot, or other information concerning the braking effort. Such feedback information may, for example, include the traditional ABS vibration felt as the actuators ‘pulse’ the brakes.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. For example, it should be apparent that the brake systems of the present invention are applicable to any brake configuration, including internal expanding brakes, caliper-type brakes and other brake types wherein a pad or other fixed surface is applied to a disc or other rotating surface to affect braking. Therefore, the scope of the appended claims should be accorded the broadest interpretation so as to encompass all such modifications and similar arrangements.

What is claimed is:

1. A vehicle brake system for use in controlling the pressure of a brake pad applied to a disc on a wheel, the system comprising:
a substantially hollow housing coupled to the brake pad and including a pressure-transmitting medium within the housing;
an actuator configured to move the housing in response to a control signal so as to control the position of the brake pad relative to the disc;
a pressure sensor configured to measure the pressure of the pressure transmitting medium and to provide a pressure signal;
a temperature sensor configured to measure the temperature of the pressure transmitting medium and to provide a temperature signal; and
a control circuit configured to receive and process the temperature and pressure signals and to provide the control signal to the actuator.

2. The vehicle brake system of claim 1, further comprising one or more hall effect sensors configured to measure one of the rotational position of the actuator and the rotational speed of the actuator.

3. The vehicle brake system of claim 1, further comprising one or more hall effect sensors configured to measure the rotational speed of a wheel located proximal the brake system.

4. The vehicle brake system of claim 1, wherein the pressure sensor, temperature sensor and control circuit are integrated on a single silicon chip.

5. The vehicle brake system of claim 4, wherein the control circuit is communicably coupled to an external electronic control unit (ECU), and wherein the control circuit provides the control signal to the actuator based on a command received from the ECU.

6. The vehicle brake system of claim 4, wherein the integrated chip is mounted within the housing.

7. The vehicle brake system of claim 1, wherein the control circuit is communicably coupled to an electronic control unit (ECU), and wherein the control circuit provides the control signal to the actuator based on a command received from the ECU.

8. The vehicle brake system of claim 7, wherein the control circuit sends status information to the ECU.

9. The vehicle brake system of claim 8, wherein the status information includes one of temperature measurement data, pressure measurement data, vibration compensation data, wheel speed data and actuator performance data.

10. The vehicle brake system of claim 8, wherein the status information is stored to a memory unit coupled to the ECU.

11. A vehicle brake system for use in controlling the pressure of a brake pad applied to a disc on a wheel, the system comprising:
a substantially hollow housing coupled to the brake pad and including a pressure-transmitting medium within the housing;
an actuator configured to move the housing in response to a control signal so as to control the position of the brake pad relative to the disc; and
an integrated circuit coupled to the housing, the integrated circuit including:
a pressure sensor configured to measure the pressure of the pressure transmitting medium and to provide a pressure signal;
a temperature sensor configured to measure the temperature of the pressure transmitting medium and to provide a temperature signal; and
a control circuit configured to receive and process the temperature and pressure signals and to provide the control signal to the actuator.

12. The vehicle brake system of claim 11, wherein the integrated circuit further includes one or more hall effect sensors configured to measure one of the rotational position of the actuator and the rotational speed of the actuator.

13. The vehicle brake system of claim 11, wherein the integrated circuit further includes one or more hall effect sensors configured to measure the rotational speed of a wheel located proximal the brake system.

14. The vehicle brake system of claim 11, wherein the integrated circuit is mounted within the housing.

15. The vehicle brake system of claim 11, wherein the control circuit is communicably coupled to an external electronic control unit (ECU), and wherein the control circuit provides the control signal to the actuator based on one or more commands received from the ECU.

16. The vehicle brake system of claim 15, wherein the control circuit sends status information to the ECU.

17. The vehicle brake system of claim 16, wherein the status information includes one of temperature measurement data, pressure measurement data, vibration compensation data, wheel speed data and actuator performance data.

18. The vehicle brake system of claim 16, wherein the status information is stored to a memory unit coupled to the ECU.

19. The vehicle brake system of claim 11, wherein the integrated circuit further includes a memory unit for storing status information.

20. The vehicle brake system of claim 11, wherein the housing has a substantially cylindrical shape.

21. The vehicle brake system of claim 1, wherein the housing has a substantially cylindrical shape.
